(19) United States
(12) Patent Application Publication
(10) Pub. No.: US 2026/0095742 A1
(43) Pub. Date: Apr. 2, 2026

(54) PROTECTED DEVICE REGISTRATION

(71) Applicant: HEWLETT PACKARD ENTERPRISE DEVELOPMENT LP, Spring, TX (US)

(72) Inventors: JOHN I. AYERS, Omaha, NE (US); TIFFANY MOORE, Omaha, NE (US); DAVID B. SCHILD, Houston, TX (US); DAVID C. WILLIAMSON, Plano, TX (US); MATHEW M. KAIPPALLIMALIL, Plano, TX (US); IAN SHELDON, Spring, TX (US); DOUGLAS HEIM, Plattsmouth, NE (US); LU TIAN, Frisco, TX (US)

(21) Appl. No.: 18/902,053

(22) Filed: Sep. 30, 2024

(51) Int. Cl. H04W 8/04; H04W 8/18; H04W 12/06; H04W 12/72

(52) U.S. Cl. CPC H04W 8/04; H04W 8/18; H04W 12/06; H04W 12/72

(57) ABSTRACT

Systems and methods are provided for protecting the registration of user equipment (UE). A temporary identifier can be assigned to a UE, and authentication and attachment of the UE to a network can be based on that temporary identifier. A protected time period can be associated with the temporary identifier to prevent collisions with another UE that may be associated with the same temporary identifier.

### BACKGROUND

Wireless or mobile devices (e.g., smart phones, tablets, and laptops) are used to send and receive data. Such data may be transmitted and received over a wireless/mobile network. 5G is a standard promulgated by the International Telecommunication Union (ITU) and the 3rd Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE, while 4G/LTE was intended to replace or augment the 3G standard. In order to be operable on a network, such as a 3G/4G/5G network, a device attaches to the network. An attach procedure is one in which the UE can register to the network to establish, e.g., a bearer or tunnel, between the device and a packet data network (PDN) gateway or similar network function (NF). Establishing the bearer or tunnel allows the device to send/receive data to/from the PDN.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example communications system within which examples of the disclosed technology may be implemented.

FIG. 2 illustrates an example home subscriber service/server (HSS) that may interact with a mobility management entity (MME) to effectuate protected registration in accordance with an example of the disclosed technology.

FIG. 3 illustrates an example message flow for handling an authentication information request during protected registration in accordance with examples of the disclosed technology.

FIG. 4 illustrates an example message flow for handling an update location request request during protected registration in accordance with examples of the disclosed technology.

FIG. 5 illustrates an example message flow for handling an update location request during protected registration in accordance with examples of the disclosed technology.

FIG. 6 illustrates an example message flow for handling a send authentication information request during protected registration in accordance with examples of the disclosed technology.

FIG. 7 is an example computing component that may execute instructions to effectuate protected registration from an HSS perspective in accordance with examples of the disclosed technology.

FIG. 8 is an example computing component that may execute instructions to effectuate protected registration from a servicing entity, e.g., MME, perspective in accordance with examples of the disclosed technology.

FIG. 9 is an example computing component that may be used to implement various features of examples of the disclosed technology.

The figures are not exhaustive and do not limit the present disclosure to the precise form disclosed.

### DETAILED DESCRIPTION

In communications networks operating in accordance with cellular standards, e.g., 3G/4G/5G communications standards, various network identifiers may be used. Permanent or temporary subscriber identities may be generated to identify particular subscribers or devices, also referred to as user equipment (UE), as well as network functions (NFs) where such subscriber records are stored. For example, an International Mobile Subscriber Identifier (IMSI) identifies a UE subscriber across any cellular network, and can be used for network authentication, location updates, and handover procedures. IMSI numbers can represent a relationship between the SIM card (or eSIM) of a UE), the country in which the UE is operational, and the mobile network in which the UE is operational. An International Mobile Equipment Identity (IMEI) identifies the type of device that a UE may be, including, e.g., manufacturer, model, or serial numbers. A UE's IMEI can be used for tracking of the UE, and for managing the UE's hardware.

In conventional networks, network providers are not able to prioritize UE registrations for a given temporary identifier, such as an IMSI, that can be assigned to multiple UEs. Because, currently, a temporary IMSI may be assigned to multiple UEs, where the UEs are distinguishable by way of another identifier (e.g., a UE's IMEI), collisions can occur between such UEs. That is, the use of the same temporary IMSI to identify multiple UEs can result in the premature/unwanted termination of previous registrations or service/service procedures. Interruptions in service may necessitate manual intervention by a network/service provider, and can create dissatisfaction in customers, e.g., end users of the UEs. Moreover, identifying and resolving such terminations/interruptions can be difficult and can take time.

Accordingly, examples of the disclosed technology are directed to a mechanism or function that allows temporary identifiers, such as temporary IMSIs, to be protected for a given duration or period of time. That is, an IMSI (or other temporary or non-unique identifier) can be specified as being a protected identifier. A subscriber database, such as a home subscriber server (HSS) can check to see whether the protected identifier is one of: not yet registered with a mobility management entity (MME); registered on a different MME than the originator of an authentication information request (AIR); or registered with the originator MME, but the corresponding protected registration time period has expired. If one of the aforementioned conditions is true/exists, the UE can be allowed to attach to a base station or an evolved node B (eNB). If, however, a UE attempts to register with the same MME, and it is determined that the UE is associated with a protected IMSI, and that the protected registration time period associated with the protected IMSI has not yet expired, the registration will be rejected or denied. For example, if another UE attempts to subsequently register with the same protected IMSI as an already-registered UE at the same MME with which the UE/protected IMSI is already registered, the attach request will be rejected.

A mobile network can be thought of as comprising two component networks, the radio access network (RAN) and the core network. In 5G cellular networking systems these components are a 5G access network (5G-AN) and a 5G core network (5GC), and in 4G/LTE cellular networking systems these components are the radio access network (RAN) and an Evolved Packet Core Network (EPC). The 5GC may include various virtualized network functions (NFs), including, for example, Core Access and Mobility Management Function (AMF) in communication with a Unified Data Manager (UDM). The AMF is configured to handle connection and mobility management tasks. The UDM is configured to manage user authentication, authorization, and device registration on the 5GC. The EPC may include its own NFs, including, for example, a Mobility Management Entity (MME) in communication with a Home Subscriber Server (HSS). The MME provides connection management functionality between UEs and the EPC. NFs may be implemented as one or more network devices or apparatuses.

The 5G standard provides for interworking with the existing 4G/LTE networks providing, among other functionality, for mobility of UEs between the 5GC and the EPC. 5G and 4G/LTE are generally mutually exclusive, such that a UE may not be attached to the EPC and the 5GC at the same time (except where the networking function of the EPC is set for dual registration), since these correspond with two types of telecommunication networks. For example, when a UE attempts to attach to the EPC, the MME serving the UE initiates a registration call flow to attach the UE to the EPC for 4G/LTE services. This call flow includes, among other functions and operations, requesting registration with the EPC. Responsive to the registration request, the MME issues an Updated Location Request (ULR) to the HSS, which may then inject a deregistration instruction into the 5GC.

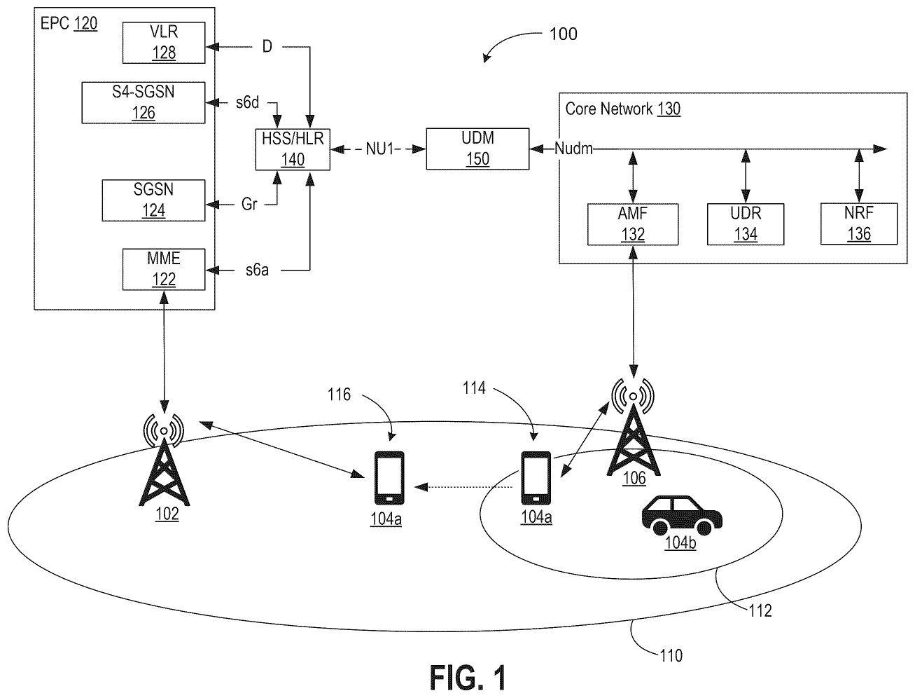

FIG. 1 illustrates an example cellular communication system 100 with which various implementations of the present disclosure may be implemented. The cellular communications system may comprise a plurality of base stations or cells (e.g., base stations 102 and 106), user equipment (UE) 104 (including UE 104a, and UE 104b), an Evolved Packet Core (EPC) 120, and another core network 130 (e.g., a 5GC) operating on different types of telecommunications networks. The base stations 102 may include macrocells (high power cellular base station) and/or small cells (low power cellular base station).

In the illustrative example of FIG. 1, base station 102 is configured according to 4G/LTE standards and interfaces with the EPC 120 through an S1 interface. Base station 106 is configured according to 5G standards and interfaces with core network 130 through an N1/N2 interface. The base stations 102 and 106 may wirelessly communicate with one or more UEs 104. Each of the base stations 102 and 106 may provide communication coverage for a respective geographic coverage area 110 and 112, respectively. There may be overlapping geographic coverage areas. For example, the base station 102 may have a coverage area 110 that overlaps the coverage area 112 of one or more other base stations, such as base station 106 as shown.

While a single base station 102 (e.g., a 4G/LTE configured base station) and a single base station 106 (e.g., a 5G configured base station) are illustrated, the cellular communication systems disclosed herein are not limited thereto. One or more base stations 102 and/or one or more base stations 106 may be provided. For example, a plurality of base stations 102 may be provided, each having a respective coverage area 110. One or more of the respective coverage areas 110 may overlap. Similarly, a plurality of base stations 106 may be provided, each having a respective coverage area 112. One or more of the respective coverage areas 112 may overlap. Furthermore, one or more coverage areas 110 may overlap with one or more coverage areas 112.

Base stations 102 and 106 may include an eNB, gNodeB (gNB), or another type of base station. Some base stations, such as base station 106, may operate in the frequency spectrum of 5G, including the low-band spectrum, i.e., the sub-1 GHz spectrum; the mid-band spectrum, i.e., the sub-6 GHz spectrum; and/or the high-band spectrum, e.g., millimeter wave (mmWave) that operates between 25 GHz and 100 GHz.

EPC 120 includes various network function entities, including, for example but not limited to, one or more MME or Mobility Management Device (MMD) 122 (used interchangeably), a Serving Gateway (S-GW) (not shown), a Packet Data Network (PDN) Gateway (not shown), among other network function entities. Although MME or MMD 122 is illustrated in FIG. 1, this device may correspond with any type of mobility management device, including a Serving General Packet Radio Service (GPRS) Support Node (SGSN), a S4-SGSN, and a Visitor Location Register in various examples, and these terms are used interchangeably throughout the disclosure.

Each MME 122 may be in communication with a Home Subscriber Server (HSS) 140 over a designated interface, for example, a S6a interface used for exchange of authentication, location, and server information about subscribers between the HSS 140 and MME 122. Each MME 122 may function as a control node that processes signaling between the UEs 104 and the EPC 120, including providing bearer and connection management functionality. The Packet Data Network (PDN) Gateway may be connected to IP Services, such as the Internet, an intranet, an IP Multimedia Subsystem (IMS), a Packet-Switched (PS) Streaming Service, and/or other IP services.

The NFs of EPC 120 may be implemented as computing systems, such as one or more servers. The NFs of the EPC 120 may communicate using protocols, such as the Diameter Protocol and/or Mobile Application Part (MAP) of the SS7 protocol. For example, the Diameter Protocol may be used for messages between the MME and the HSS or an S4-SGSN and the HSS, while MAP may be used for messages between a Home Location Repository (HLR) and a SGSN or VLR. Data included in the messages on the EPC may be formatted according to American Standard Code for Information Interchange (ASCII) protocols.

Core network 130 may include various virtualized network functions (NFs), including, for example but not limited to, an Authentication Server Function (AUSF) (not shown), Core Access and Mobility Management Function (AMF) 132, a policy control function (PCF) (not shown), a session management function (SMF) (not shown), a Unified Data Repository (UDR) 134, and a Network Repository Function (NRF) 136, to name a few. For example, AMF 132 may be the control node that processes the signaling between UEs 104, via base station 106 and core network 130.

AMF 132 may receive connection and mobility management tasks from UEs 104 and can handle connection and mobility management tasks, while forwarding session management tasks/messages to a Session Management Function (SMF). AMF 132 may be in communication with UDM 150 over a service-based interface (SBI) for UDM 150, such as a Nudm interface.

Core network 130 may also include NRF 136, which provides for network function service registration, authorization, and discovery, and otherwise enables network functions to identity one another. Core network 130 may also include a User Plane Function (UPF) (not shown) that is connected to IP Services, which may include the Internet, an intranet, an IMS, a PS Streaming Service, and/or other IP services.

The NFs of core network 130 may be implemented as computing systems, such as one or more servers. The NFs of core network 130 may communicate using protocols, such as HyperText Transfer Protocol (HTTP). Communications and operations may be sent, for example, using HTTP methods, such as POST, PATCH, GET, PUT, etc.

As noted herein, AMF 132 may receive connection and session-related information from UEs across N1/N2 reference point interfaces (between UE and AMF/between RAN and AMF), but may handle connection and mobility management tasks. That is, an AMF instance may be specified by a UE, e.g., UE 104a or 104b, in a Non-Access Stratum (NAS) message that is routed to the AMF instance by the RAN. Performing the role of an access point to the 5G core network (terminating the RAN control plane and UE traffic), the AMF instance may authenticate the UE and manage, e.g., handovers, for the UE between access points, base stations, and gNBs.

UDM 150 provides services to other functions of the Service-Based Architecture (SBA), such as AMF 132 and other network functions. UDM 150 may store information in local memory. UDM 150 may also store information externally, for example, within UDR 134. UDM 150 may provide authentication credentials while being employed by AMF 132 to retrieve subscriber data and access registration context data.

Although the preceding description may provide examples based on 5GC and 4G/LTE, it should be appreciated that the concepts described therein may be applicable to other types of telecommunication networks. For example, the concepts described herein may be applicable to legacy networks, such as, GPRS, CDMA, GSM, and/or other wireless technologies in which a UE may operate. For example, EPC 120 may include network functions of the legacy types of telecommunication networks. GPRS core networks included a SGSN configured to perform functions similar to MME 122. EPC 120 may include or be communicably coupled to a SGSN 124 that communicates with the HSS 140 via a designated interface, such as, a Gr interface for routing information between the SGSN 124 and the HSS/HLR 140. In some GPRS core networks, an S4-SGSN is used for performing functions similar to MME 122. EPC 120 may include or be communicably coupled to a S4-SGSN 126 that communicates with HSS 140 via a designated interface, such as, a s6d interface used for exchange of authentication, location, and server information about subscribers between HSS 140 and S4-SGSN 126. GSM core networks include a Visitor Location Register (VLR) configured to perform functions similar to the MME 122 and a HLR performing functions similar to HSS 140. EPC 120 may include or be communicably coupled to VLR 128 that communicates with HSS 140 via a designated interface, such as a D interface used for routing information between a VLR 128 and the HSS/HLR 140.

The term “mobility management entity” (MME) or “mobility management device” (MMD) can be used herein to refer to one or more of an MME, SGSN, S4-SGSN, VLR, or similar network function entity included in the EPC, while “legacy mobility management device” will be used herein to refer to one or more of SGSN, S4-SGSN, VLR and the like. Additionally, “location and service information interface” may be used to refer to one or more of the S6a, s6d, D, Gr, or similar interfaces between the HSS and a respective mobility management device.

Base stations 102 and/or 106 may provide an access point to EPC 120 or core network 130 for UE 104. Examples of UEs 104 include cellular phones, smart phones, laptop computers, tablet computers, personal computers, vehicle-implemented communication devices (e.g., vehicles having vehicle-to-vehicle (V2V) capabilities), multimedia devices, game consoles, wearable devices, or any other similar functioning device. Some of UEs 104 may be referred to as IoT devices (e.g., parking meter, gas pump, toaster, vehicles, heart monitor, etc.). Each UE may move about the cellular network system 100 into and out of respective coverages areas (e.g., coverage area 110 and 112).

As noted herein, 5G provides for interworking with the existing EPC providing for mobility of UEs between 5G and 4G/LTE, for example, or other types of telecommunication networks. Accordingly, 5G provides for service migration by attaching to and from each network as the UE moves into and out of coverage areas. Thus, interworking between the networks allows for migration of attachment between the 5GC and EPC through communication between UDM 150 and HSS 140 via a NU1 interface.

For example, as shown in FIG. 1, UE 104a (illustrative depicted as a mobile smartphone) moves from first position 114, in coverage area 112, to second position 116, out of coverage area 112, as shown by the dotted arrow. If UE 104a is capable of receiving 5G services, while present in coverage area 112, UE 104a may be registered with and attached to AMF 132. Upon moving out of coverage area 112 to the 4G coverage area 110, UE 104a will attempt to attach to EPC 120 via a registration request to the MME 122. Once registered and attached to MME 122, UE 104a is able to receive 4g/LTE services via EPC 120.

An interworking function facilitates the transition between networks to ensure that seamless transition is achieved. For 5G and EPC interworking, there are generally two solutions: single registration solution and dual registration solution. With the single registration, the UE 104a is permitted to attach to one of the EPC or 5G telecommunication networks at any point in time. Accordingly, a deregistration of the other telecommunication network may be exchanged through a control interface between the telecommunication networks, for example, between HSS 140 to UDM 150 over a NU1 interface when the attachment status of UE 104a is updated. With dual registration, UE 104a may be registered to both the EPC or 5GC telecommunication networks at any point in time, and thus there is no deregistration instruction transmitted as an electronic communication or message between the HSS and the UDM.

As an illustrative example, FIG. 1 shows UE 104a at first position 114, at which point the UE 104a is registered with AMF 132 for receiving 5G services. When UE 104a moves to second position 116, UE 104a moves out of the 5G coverage area 112 and needs to attach to EPC 120 to receive 4G/LTE services, which allows UE 104a to move from a first type of telecommunication network to a second type of telecommunication network. To do so, UE 104a issues a registration request to a MME 122 of EPC 120 and MME 122 sends an update location request (ULR) to the HSS 140, via a respective location and service information interface. For example, a ULR is transmitted according to the Diameter Protocol and an Update Location is transmitted according to the MPA protocol. The term “update location request” or “ULR” will be used herein to refer to an Update Location Request sent under the Diameter protocol and/or an Update Location sent under the MAP protocol. HSS 140 checks subscriber data to confirm UE 104a is permitted to attach to EPC 120 and other subscription information and, if so, issues an Update Location Answer (ULA) to the mobility management device. Based on the ULA, UE 104a is registered with and attached to MME 122 for rendering of services in the 4G/LTE telecommunication network.

In either scenario described above, when UE 104a attempts to attach to EPC 120 via a registration request to the MME 122, an authentication information request (AIR) message may be transmitted by MME 122 to HSS 140 which includes an IMSI assigned to UE 104a. Conventionally, UE 104a may be identified by, e.g., an IMEI for eSIM activation, and can be registered to MME 122 with a temporary user ID, e.g., a temporary IMSI. After UE 104a's identification is validated, EPC 120 can download a unique user ID, e.g., a permanent IMSI to UE 104a so that services can ultimately be provided to UE 104a.

However, the assignment of a temporary user ID, such as a temporary IMSI, as noted above, can cause issues. For example, consider a scenario where UE 104b also attempts to attach to EPC 120, and register with MME 122. In the event that UE 104b is assigned the same temporary user ID, e.g., the temporary IMSI that was assigned to UE 104a, a collision may occur, whereby the registration of UE 104a (if still ongoing) or a service(s) provided by communication system 100 can be disrupted or canceled.

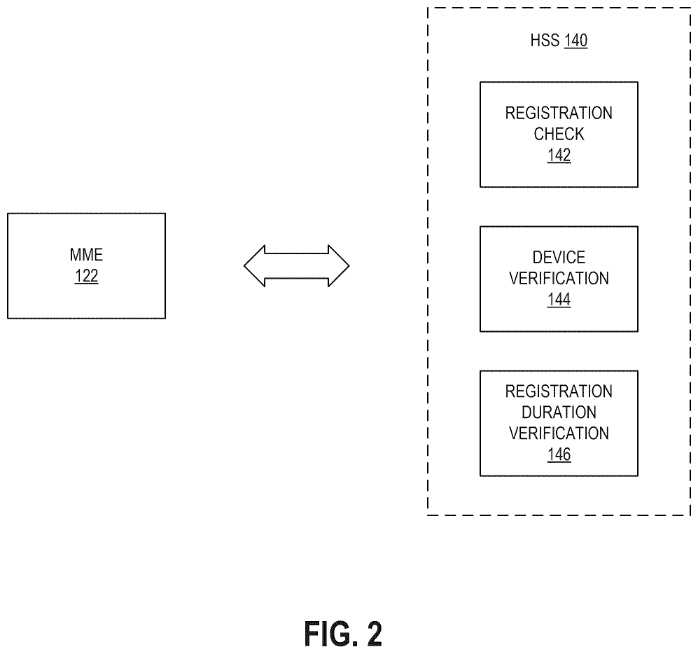

Instead, and in accordance with examples of the disclosed technology, temporary user IDs, such as temporary IMSIs can be designated or flagged as being protected and a protected registration duration or time period can also be specified for that protected temporary user ID. It should be noted that a network operator may assign a temporary IMSI, where the HSS is aware of the temporary nature of the IMSI because a subscriber “protected registration” flag can be set. Network operators typically use temporary IMSIs prior to assigning permanent identifiers. That is, MME 122 may receive an attach request from UE 104a, and MME 122 may transmit an AIR message to HSS 140. HSS 140 may then check or determine if the temporary IMSI of UE 104a is a protected IMSI. If the IMSI is indeed a protected IMSI, HSS 140 can determine if UE 104a has already registered with MME 122 by checking whether a UE with the same protected IMSI is already registered with MME 122, and whether that UE's IMEI matches that of UE 104a. If there is no match or if UE 104a is registered with a different MME than MME 122, or if a UE with a different IMEI is already registered with MME 122, but the protected registration duration associated with the already-registered UE has expired, MME 122 can proceed with registration, and UE 104a can be attached to EPC 120 (e.g., an eNB of communication system 100). Otherwise, registration/attachment by UE 104a can be denied or rejected by HSS 140. In this way, an existing registration/attachment of a UE to an MME/EPC can be protected for a specified amount of time from colliding or interfering registrations/attachments by other UEs FIG. 2 illustrates example components or modules of an example HSS, e.g., HSS 140 (FIG. 1), that operates in conjunction with an MME, e.g., MME 122 (FIG. 1) to perform registration and attach operations with UEs of a network. A UE may attempt to attach to a particular eNB or other base station, and may transmit an attach request message to an MME, e.g., MME 122. MME 122 can transmit an AIR message with the UE's temporary IMSI to HSS 140. Registration check module 142 may check to determine if a protected registration feature or function is enabled, and if so, registration check module 142 can compare the IMSI (and the source MME's identifier) received with the AIR message with the IMSI/source MME identifier that was subsequently received to see if a registration with MME 122 associated with the same IMSI already exists. If so, HSS 140 can deny the attach request (although if the same IMSI already exists but is associated with the same IMEI or other matching identifier, the attach request is considered a re-registration from the same UE and can be processed). If not, device verification module 144 can generate some given (configurable) number of authorization vectors for the protected IMSI. This can ensure that MME 112 will send a new AIR message to HSS 140 any time a UE attempts to attach to the network. Additionally, the Mobile Application Part (MAP) update location (UL) and Update GPRS location (UGL) logic are allowed to avoid canceling a previous Visiting Location Register (VLR) or Service GPRS Support Node (SGSN) registration with a different Public Land Mobile Network (PLMN) ID if still within the protected registration time period. That is, if the inbound registration request is from a different UE (i.e., the UE identifiers don't match), registration duration verification module 146 can compare a time associated with a new inbound registration request and a stored timestamp associated with a current protected registration. If the amount of time that has elapsed between receipt of registration request and the stored timestamp exceeds the system-level/defined protected registration time duration, the new registration request may be processed/honored. This results in the cancellation of the previous registration, thus allowing a new registration to complete, which results in the granting of service for that UE. If registration duration verification module 146 determines that the current registration is still within the protected time duration, the currently-registered device will be protected, and the new inbound registration request will be rejected/denied. The UE seeking to attach/register with the network can be assigned a different temporary user ID, e.g., temporary IMSI, to re-register itself.

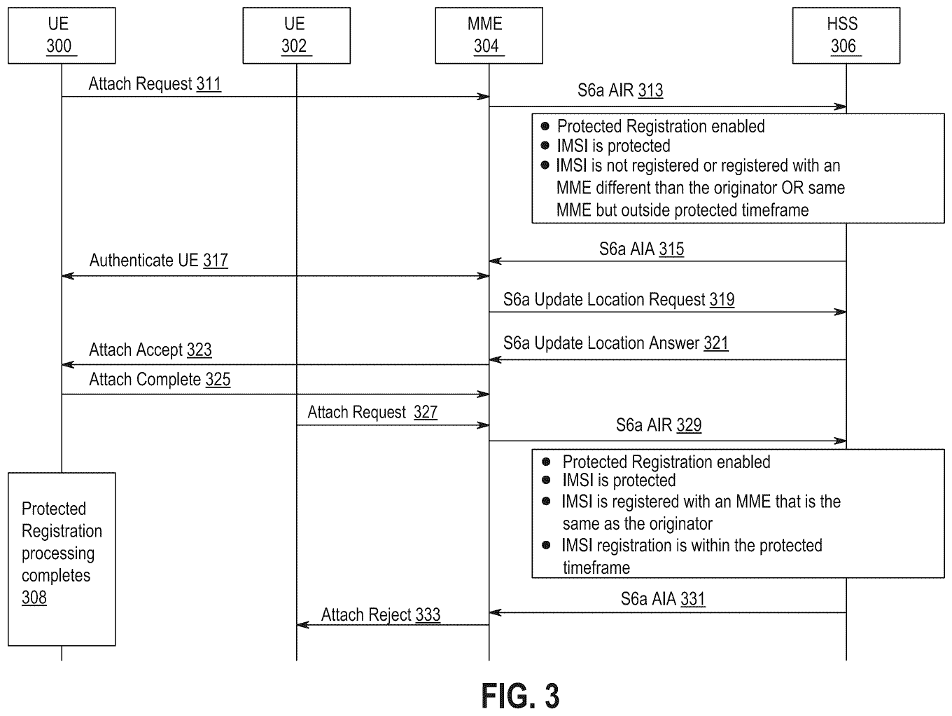

FIG. 3 illustrates an example message flow regarding the handling of an AIR procedure during a protected registration. A subscriber, by virtue of location, movement, roaming, powering on a UE, etc., may wish to attach the UE to a network. As noted above, the attach procedure is the procedure during which a UE can register to the network and create a bearer/tunnel between the UE and the PGW so that the UE can begin sending/receiving data over the network. In FIG. 3, a first UE 300 may send an attach request 311 to MME 304.

MME 304 may transmit an S6a AIR message 313 to HSS 306 that includes a temporary ISMI (or other identifier) assigned to first UE 300. The AIR message 313 is sent (by the MME or SGSN) requesting authentication credentials from the HSS. Such authentication credentials are typically referred to as “authentication vectors” for authenticating and authorizing a subscriber. HSS 306 may check to determine whether protected registration is enabled on the system. In the event the temporary IMSI assigned to first UE 300 is a protected IMSI, HSS 306 may then make additional determinations. In particular, HSS 306 may check to determine whether or not the IMSI is not registered with MME 304 (the MME with which first UE 300 wishes to register, and from which the S6a AIR message originated), or whether the IMSI is registered with a different MME than the originating MME (i.e., MME 304). HSS 306 may also check to determine whether, if the IMSI is registered to the same/originating MME (i.e., MME 304), that the IMSI is outside its protected registration timeframe or time period. If the IMSI is not protected, or the IMSI is not registered at all/not registered to the originating MME, or the IMSI is protected, but its protected registration time period has expired, HSS 306 may proceed with registration (and ultimately, completing attachment of first UE 300 to an eNB). In the scenario illustrated in FIG. 3, first UE 300 is allowed to register/attach. With protected registration enabled on the network (in some examples, the protected registration feature is enabled/disabled on a system-or network-wide level).

That is, HSS 306 sends an S6a Authentication Information Answer (AIA) message 315 that includes the requested authentication/authorization information in the form of authentication vectors. In some examples of the disclosed technology, the number of authentication vectors HSS 306 returns to MME 304 is configurable. HSS 306, in some examples, returns the configured number of authentication vectors regardless of what was requested in the AIR message 313. For example, in some scenarios, regardless of how many authentication vectors may be requested, HSS 306 may return just a single authentication vector, prioritizing completion of the attachment. Typically, AIA message 315 comprises attribute-value pairs (AVPs) within which information can be carried. In this example, AVPs carry data, such as authentication data, security data, application data, etc. An AVP code can identify an attribute, and an AVP flag can inform a receiver (in this example, MME 304) as to how each received attribute should be handled.

MME 304 and first UE 300 may then engage in an authentication process 319 for authenticating first UE 300. Typically, the AMF (in 3G/4G LTE) or the MME (in 5G) will generate an authentication challenge for first UE 300, which includes some random number as well as an expected authentication response. First UE 300 may compute the authentication response based on the challenge, and its security credentials, returning the computed authentication response back to the AMF/MME. If the response matches the expected authentication response (value), first UE 300 is successfully authenticated.

After authentication, HSS 306 receives and processes an S6a update location request (ULR) 319 from MME 304. As would be understood by those skilled in the art, the ULR is used to update the location of a UE in the HSS when the UE moves from one location to another. HSS 306 may check to determine whether the IMSI specified in ULR 319 is known. Location information can be used to ensure incoming calls, messages, data, etc. can be correctly routed to first UE 300. Upon receipt of ULR 319, HSS 306 may retrieve the subscriber profile associated with first UE 300, which includes the new serving network element, e. g, MME 304. HSS 306 also updates the location associated with the subscriber/UE 300 to reflect MME 304 as serving first UE 300 (UE 300 registers with MME 304). It should be noted that the ULR, e.g., ULR 319, is also used to determine what services the subscriber can use, once authentication/security setup are complete, and MME 304 is registering the subscriber/first UE 300 with the network.

HSS 306 may then return the subscriber profile it retrieved (associated with first UE 300) in an S6a Update Location Answer (ULA) message 321. ULA message 321 is an acknowledgment to MME 304 that the location information regarding first UE 300 has been successfully updated per MME 304's ULR.

Thereafter, first UE 300 may accept attachment 323 to the network, and respond with attachment complete message 325 sent to MME 304. Recalling that protected registration was enabled, a protected registration duration 308 is established during which, any attempt to attach/register with a temporary IMSI that is the same as that associated with first UE 300, is denied or rejected. In the example scenario of FIG. 3, a second UE 302 sends an attach request 327 to MME 304, similar to the manner in which first UE 300 sent attach request 311 to MME 304. Likewise, MME 304 sends an AIR message 329 to HSS 306 which comprises the same temporary IMSI as that associated with first UE 300.

HSS 306, as described above, determines whether protected registration is enabled in the system. As discussed above, in this example protected registration is enabled. HSS 306 determines whether the received IMSI is protected - in this example, as discussed above, the IMSI is indeed, protected. As also discussed above, HSS 306 may check to determine whether or not the IMSI is registered with the same MME as the originating MME (in this example, MME 304). HSS 306 determines that the IMSI associated with second UE 302 is already registered with MME 304 (by way of first UE 300 registering with MME 304). Looking at the time of the attach request message 327 and the stored timestamp of the protected registration duration for the temporary IMSI, HSS 306 may determine, in this scenario, that the protected registration duration or time period is still in effect. Accordingly, HSS 306 transmits an S6a AIA message 331 indicating an error (which in some examples of the disclosed technology, may be configurable). MME 304 correspondingly transmits an attach reject message with a Non Access Stratum (NAS) protocol cause code 333 (NAS being used between UEs and MMEs to facilitate mobility and session management). Second UE 302 may be prompted or triggered to select a different IMSI, and may attempt to register with MME 304 and attach to the network again.

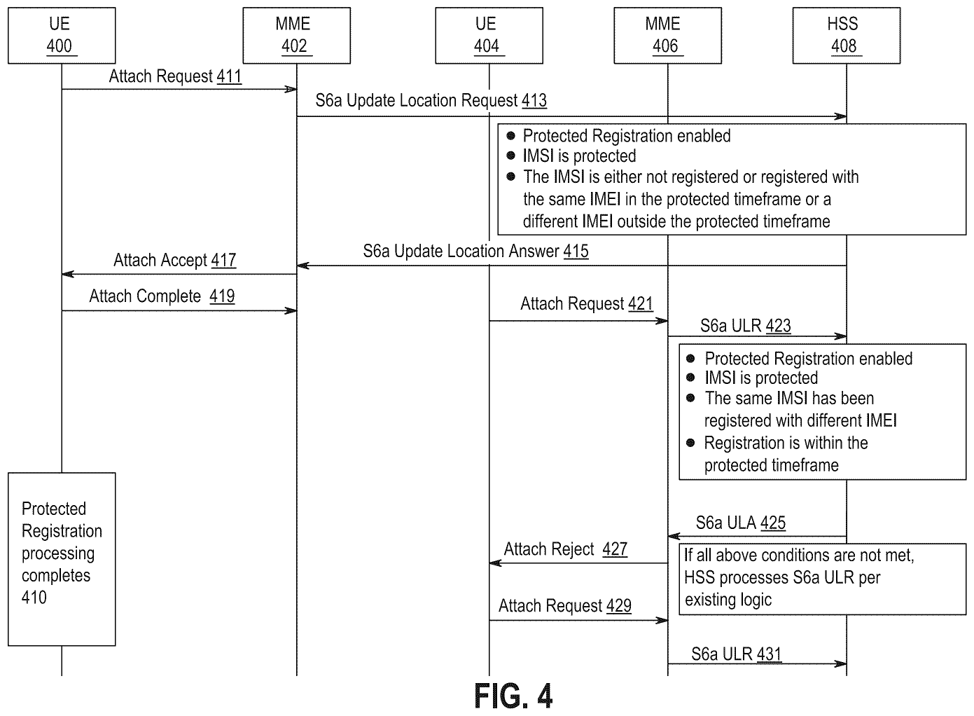

FIG. 4 illustrates an example message flow regarding the handling of the ULR procress during a protected registration. As noted above, a subscriber, by virtue of location, movement, roaming, powering on a UE, etc., may wish to attach the UE to a network. As also noted above, the attach procedure is the procedure during which a UE can register to the network and create a bearer/tunnel between the UE and the PGW so that the UE can begin sending/receiving data over the network.

In FIG. 4, a first UE 400 may send an attach request 411 to a first MME 402. This attach request 411 may comprise a Globally Unique Temporary UE Identity (GUTI), in other words, the temporary IMSI discussed herein, for example. In addition, the attach request 411 may comprise the name of the access point (APN), base station/eNB, etc. to which the UE wishes to connect (APs can be considered a type of base station as well). As discussed above, a subscriber may request to attach to a network element/device pursuant to initially powering up the UE, changing location, etc. In the example message flow of FIG. 4, it is assumed that first UE 400 which sent attach request message 411 to first MME 402, has already been authenticated/authorized by first MME 402, and first MME 402 has established a secure mechanism (e.g., tunnel) between first UE 400 and first MME 402 over which messages can be securely exchanged. The attach request sent by first UE 400 can be an attach request sent pursuant to moving locations, prompting first UE 400 to attach to a different AP/eNB from that to which it may currently attached.

That is, and similar to the example message flow of FIG. 3, here (although not shown), first MME 402 (or an AMF) will have generated an authentication challenge for UE 400, which includes some random number as well as an expected authentication response. UE 400 may have computed the authentication response based on the challenge, and its security credentials, returning the computed authentication response back to the AMF/MME. If the response matches the expected authentication response (value), UE 400 will have been successfully authenticated.

After authentication, HSS 408 receives and processes a ULR 413 from first MME 402. As noted above, the ULR is used to update the location of a UE in the HSS when the UE moves from one location to another. Location information can be used to ensure incoming calls, messages, data, etc. can be correctly routed to first UE 400. Upon receipt of ULR 413, HSS 408 may retrieve the subscriber profile associated with first UE 400, which includes the new serving network element, e.g., first MME 402. HSS 408 also updates the location associated with the subscriber/first UE 400 to reflect first MME 402 as serving first UE 400.

HSS 408 may check to determine whether protected registration is enabled on the system. In the event the temporary IMSI assigned to first UE 400 is a protected IMSI, HSS 408 may check to determine whether or not the IMSI is not registered with first MME, or whether the IMSI is registered with a different MME than the originating MME (i.e., first MME 402). HSS 408 may also check to determine whether, if the IMSI is registered to the same/originating MME (i.e., first MME 402), that the IMSI is outside its protected registration timeframe or time period. If the IMSI is not protected, or the IMSI is not registered at all/not registered to the originating MME, or the IMSI is protected, but its protected registration time period has expired, HSS 408 may proceed with registration (and ultimately, completing attachment of first UE 400 to an eNB).

HSS 408 may then return the subscriber profile it retrieved (associated with first UE 400) in a ULA message 415. As discussed above, ULA message 415 is an acknowledgment to first MME 402 that the location information regarding first UE 400 has been successfully updated per first MME 402's ULR.

Thereafter, first UE 400 may accept attachment 417 to the network, and respond with attach complete message 419 sent to first MME 402. Recalling that protected registration was enabled, a protected registration duration 410 is established during which, any attempt to attach/register with a temporary IMSI that is the same as that associated with first UE 400, is denied or rejected. In the example scenario of FIG. 4, a second UE 404 sends an attach request 421 to second MME 406, similar to the manner in which first UE 400 sent attach request 413 to first MME 402.

Assuming authentication of second UE 404 has already been completed, and after such authentication, HSS 408 receives and processes a ULR 423 from second MME 106. As noted above, the ULR is used to update the location of a UE in the HSS when the UE moves from one location to another. Location information can be used to ensure incoming calls, messages, data, etc. can be correctly routed to second UE 404. Upon receipt of ULR 423 (where in this example, both first UE 400 and second UE 404 are assigned the same temporary IMSI, but are distinguished from one another by, e.g., their respective IMEIs, which are different.

HSS 408 may check to determine whether protected registration is enabled on the system. In the event the temporary IMSI assigned to first UE 400 is a protected IMSI, HSS 408 may check to determine whether or not the IMSI is not registered with first MME, or whether the IMSI is registered with a different MME than the originating MME (i.e., first MME 402). HSS 408 may also check to determine whether, if the IMSI is registered to the same/originating MME (i.e., first MME 402), that the IMSI is outside its protected registration timeframe or time period. If the IMSI is not protected, or the IMSI is not registered at all/not registered to the originating MME, or the IMSI is protected, but its protected registration time period has expired, HSS 408 may proceed with registration (and ultimately, completing attachment of first UE 400 to an eNB).

In this example scenario, the same temporary IMSI that has been assigned to first and second UEs 400 and 404 (which have different IMEIs), and both first and second UEs 400 and 404 are currently registered to first MME 402. HSS 408 may further determine that the mutually-assigned temporary IMSI is a protected IMSI, and that this particular protected IMSI is still within its protected registration timeframe 410. This is an example of a scenario wherein allowing second UE 404 to proceed with attaching/registration (on the same temporary IMSI) to second MME 406 would disrupt services to first UE 400.

HSS 408 may then return an error code/message in a ULA message 425. This ULA message 425 notifies second MME 406 that the attach request 421 transmitted by second UE 404 is being rejected. Thus, second MME 406 transmits an attach reject message 427 to second UE 404, which includes a NAS cause code (described above) reflecting the reason/cause of this attach rejection.

In this case, second UE 404 may select another temporary IMSI for attachment/registration purposes, and may send another attach request 429 to second MME 406. MME 406 can send another ULR message 431 to HSS 408 (now with a different IMSI than the protected IMSI being associated with second UE 404). HSS 408, as described above, can check for conditions regarding protected registration (whether the protected registration feature is enabled, whether the received IMSI is protected, where the protected IMSI has been registered/is currently registered, and whether the protected IMSI is still within its configured protected registration time period. Here, the conditions may dictate that second UE 404 can attach to the network/register with second MME 406.

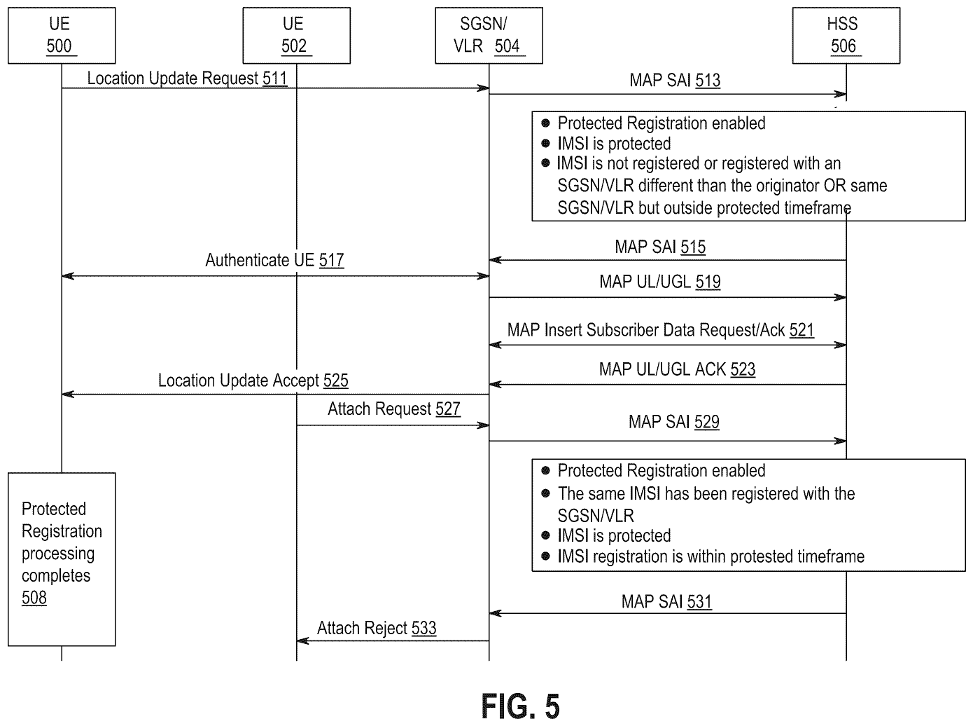

FIG. 5 illustrates an example message flow regarding the handling of a send authentication information (SendAuthInfo/SAI) procedure during protected registration in accordance with examples of the disclosed technology. In FIG. 5, SGSN/VLR 504 receives an attach request from first UE 500 in the form of location update request 511. It should be noted that a location update for non-Evolved Packet System (EPS) services can be initiated with a combined attach or tracking area update procedure.

SGSN/VLR 504 may transmit a Mobile Application Park MAP send authentication information (SAI) message 513 to HSS 506. It should be noted that in this example, HSS 506 can refer generally to any home subscriber server/service/register, such as a home location register (HLR). SAI messages, like SAI message 513, are typically sent to retrieve authentication information, in this scenario, from HSS 506. The SAI request attributes can include an invoke ID to identify corresponding service primitives for first UE 500, the IMSI associated with first UE 500, which can be a temporary IMSI prior to being configured with a permanent IMSI, and the minimum number of authentication vectors needed to perform authentication.

As with other example scenarios described herein, HSS 506 may check to determine whether protected registration is enabled on the system. In the event the temporary IMSI assigned to first UE 500 is a protected IMSI, HSS 506 may then make additional determinations: whether or not the IMSI is not registered with SGSN/VLR 504; whether the IMSI is registered with a different SGSN/VLR than the originating SGSN/VLR (i.e., SGSN/VLR 504). HSS 506 may also check to determine whether, if the IMSI is registered to the same/originating SGSN/VLR (i.e., SGSN/VLR 504), that the IMSI is outside its protected registration timeframe or time period.

HSS 506 sends a MAP SAI response message 515 to SGSN/VLR 504 that includes the requested authentication/authorization information in the form of authentication vectors. In some examples of the disclosed technology, the number of authentication vectors HSS 506 returns to SGSN/VLR 504 is configurable.

SGSN/VLR 504 and first UE 500 may then engage in an authentication process 517 for authenticating first UE 500. After authentication, HSS 506 receives and processes a MAP update location (UL)/update General Packet Radio Service (GPRS) (UGL) request 519 from SGSN/VLR 504. As would be understood by those skilled in the art, the MAP UL/UGL request 519 can be sent in order to update the location information currently stored in HSS 506 with the relevant location update request attributes. HSS 506 and SGSN/VLR 504 may exchange MAP insert subscriber data request and acknowledge messages 521. Such insert subscriber data messages effectuate the Subscriber Data Handling procedure in LTE for managing subscriber/subscription data in the MME and SGSN/VLR over the S6a/s6d interface. Once SGSN/VLR 504 receives its requested subscriber data, HSS 506 can send a MAP UL/UGL acknowledgment message 523 to SGSN/VLR 504 indicating acceptance or completion of the location update at HSS 506 regarding first UE 500. SGSN/VLR 504 may then send a location update accept message 525 indicating to first UE 500 that its location information has been updated in HSS 506.

In the example scenario of FIG. 5, a second UE 502 sends an attach request 527 to SGSN/VLR 504. SGSN/VLR 504 sends a MAP SAI message 529 in order to retrieve authentication information from HSS 506. HSS 506, as described above, determines whether protected registration is enabled in the system. In this example, protected registration is enabled. HSS 506 determines whether the received IMSI is protected - in this example, as discussed above, the IMSI is indeed, protected. HSS 506 may check to determine whether or not the IMSI is registered with the same SGSN/VLR, in this example, SGSN/VLR 504). HSS 506 determines that the IMSI associated with second UE 504 is already registered with SGSN/VLR 504. Looking at the time of the attach request message 527 and the stored timestamp of the protected registration duration 508 for the temporary IMSI, HSS 506 may determine, in this scenario, that the protected registration duration or time period is still in effect. Accordingly, HSS 506 transmits a MAP SAI message 531 indicating an error (which in some examples of the disclosed technology, may be configurable). SGSN/VLR 504 correspondingly transmits an attach reject message 533 with an appropriate NAS protocol cause code.

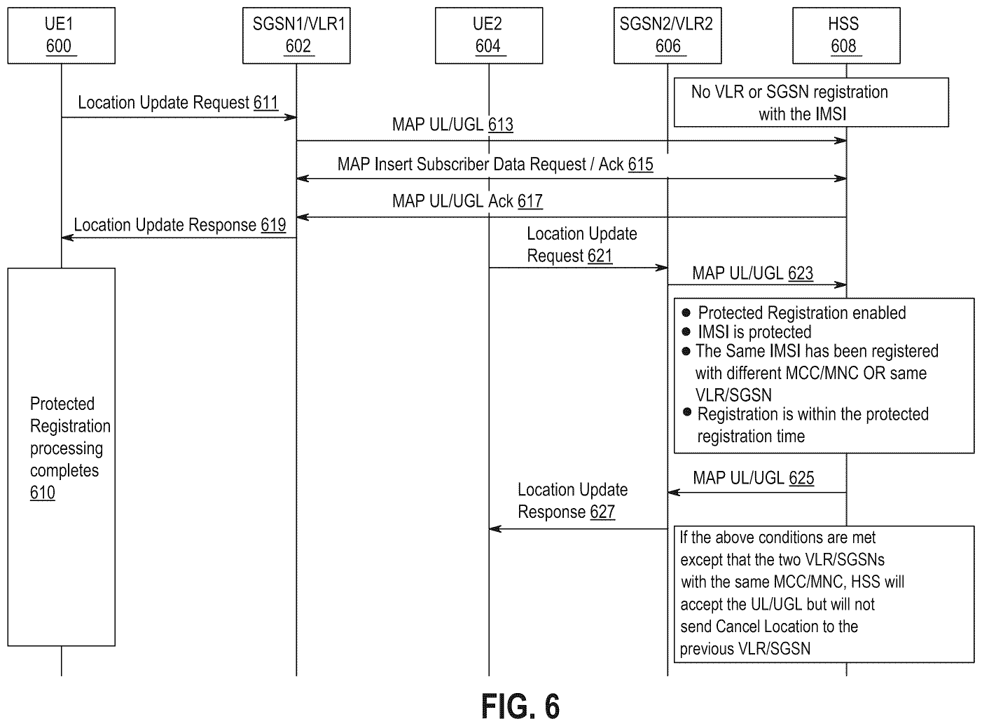

FIG. 6 illustrates an example message flow regarding the handling of a the aforementioned UL/UGL process during protected registration in accordance with examples of the disclosed technology. In FIG. 6, first SGSN/VLR 602 receives an attach request from first UE 600 in the form of location update request 611. As noted above, a location update for non-Evolved Packet System (EPS) services can be initiated with a combined attach or tracking area update procedure. It should be noted that the temporary IMSI associated with first UE 600 is not registered in first SGSN/VLR 602.

HSS 608 receives and processes a MAP UL/UGL request 613 from SGSN/VLR 504, which can be sent in order to update the location information currently stored in HSS 608 with the relevant location update request attributes. HSS 608 and first SGSN/VLR 602 may exchange MAP insert subscriber data request and acknowledge messages 615. As discussed above, insert subscriber data messages effectuate the Subscriber Data Handling procedure in LTE for managing subscriber/subscription data in the MME and SGSN/VLR over the S6a/s6d interface. Once SGSN/VLR 602 receives its requested subscriber data (by way of a subscriber profile for first UE 600), HSS 608 can send a MAP UL/UGL acknowledgment message 617 to first SGSN/VLR 602 indicating acceptance or completion of the location update at HSS 608 regarding first UE 600. First SGSN/VLR 602 may then send a location update response message 619 indicating to first UE 600 that attachment to the network has been completed.

In the example scenario of FIG. 6, a second UE 604 sends its own location update request (attach request) message 621 to second SGSN/VLR 606 (similar to first SGSN/VLR 602 receiving a location update request message 611 from first UE 600). Second SGSN/VLR 606 may then transmit UL/UGL request 623 to update the location information associated with second UE 604. It should be noted that the MAP protocol provides an application layer for various network nodes/elements in order to allow for those nodes/elements to communicate with one another. The MAP protocol (at least in terms of the MAP UL/UGL procedure) is reliant on a UE's IMSI as an identifier. The MAP protocol, as specified by the International Telecommunication Union Telecommunication Standardization Sector (ITU-T) and the European Telecommunications Standards Institute (ETSI), does not utilize a UE's IMEI for identification.

HSS 608 determines whether protected registration is enabled in the system. In this example, protected registration is enabled. HSS 608 determines whether the received IMSI is protected—in this example, the IMSI is protected. HSS 608 may check whether or not the IMSI is registered with the same SGSN/VLR or is associated with a different mobile country/network code (MCC/MNC tuple that identifies a network). In this example, it may be that HSS 608 determines that the IMSI associated with second UE 604 is already registered with first SGSN/VLR 602. Looking at the time of the attach request message (in this example, the location update request message 621), and the stored timestamp of the protected registration duration 610 for the temporary IMSI, HSS 608 may determine that the protected registration duration or time period is still in effect. Accordingly, HSS 608 transmits a location update response message 627 that includes a NAS cause code indicating rejection of the location update request. If HSS 608 were to update the location of second UE 604 (based on the temporary IMSI that is associated with both first UE 600 and second UE 604), the location of first UE 600 would be updated to second SGSN/VLR 606 causing a collision/problems. For example, a sender wishing to communicate with first UE 600 may transmit data in accordance with the updated location/registration with second SGSN/VLR 606 despite the location of first UE 600 being established, remaining unchanged, at HSS 608 (by first SGSN/VLR 602).

Thus, second UE 604 may select a different temporary IMSI to be associated with, and can retry performing a location update with HSS 608. It should be noted that if the protected registration checks/determinations made by HSS 608, in this example, is such that protected registration is enabled, the temporary IMSI as issue is protected and within its specified protected registration duration, but the first and second UEs 600, 604 are registered with different SGSN/VLRs (MCC/MNCs), HSS 608 can accept the location update request/update the location of second UE 604. However, HSS 608 will not send a cancel location request to the previous SGSN/VLR. In this way, the other UE's, e.g., first UE 600's, location remains the same, i.e., a collision between first UE 600 and second UE 604 due to having the same temporary IMSI can be avoided.

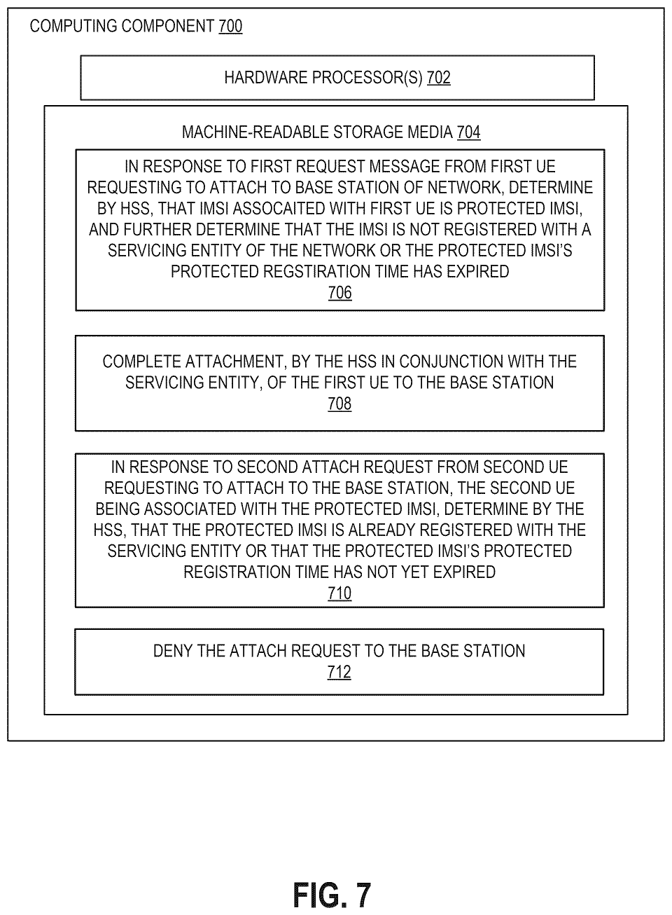

FIG. 7 illustrates a computing component that may be used to execute instructions to effectuate protected registration in accordance with examples of the disclosed technology. Referring now to FIG. 7, computing component 700 may be, for example, a server computer, a controller, or any other similar computing component capable of processing data. In the example implementation of FIG. 7, computing component 700 includes a hardware processor 702, and machine-readable storage media 704. Computing component 700 may be used to embody, e.g., HSS functionality in accordance with one example of the disclosed technology.

Hardware processor 702 may be one or more central processing units (CPUs), semiconductor-based microprocessors, and/or other hardware devices suitable for retrieval and execution of instructions stored in machine-readable storage media 704. Hardware processor 702 may fetch, decode, and execute instructions, such as instructions 706-712. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 704, may be any electronic, magnetic, optical, or other physical storage device that contains or stores executable instructions. Thus, machine-readable storage media 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 404 may be a non-transitory storage medium, where the term “non-transitory” does not encompass transitory propagating signals. As described in detail below, machine-readable storage media 704 may be encoded with executable instructions, for example, instructions 706-712.

Hardware processor 702 may execute instruction 706 to, in response to a first request message from a first UE requesting to attach to a base station of a network, determine by an HSS, that an IMSI associated with the first UE is a protected IMSI, and further determine that the IMSI is not registered with a servicing entity of the network or the protected IMSI's protected registration time has expired. As discussed above, the first request message from the first UE may be, e.g., an attach request sent to a servicing entity, such as an MME or an SGSN/VLR. The base station, as would be understood by those of ordinary skill in the art, can refer to a network element/site that connects mobile devices, such as UEs to a communications network. A base station can also act as a hub for a wireless network, and may be leveraged to connect a wired network to a wireless network. In some scenarios, the base station can be an AP, which functions as a base station, e.g., when connected to the Internet with a wired connection. That is, an AP can act as a WiFi base station. In order to attach to a network, a UE requests to attach to a base station, such as an AP or an eNB. The servicing entity may send an authentication request to the HSS with the temporary IMSI associated with the UE. The HSS may perform protected registration checks as set forth above to determine whether or not a subsequent attach request from another UE (associated with the same temporary IMSI) can proceed with attachment/registration, or if the attach request will be denied.

If conditions for attaching the UE to the network/base station are met, hardware processor 702 may execute instruction 708 to complete attachment, by the HSS in conjunction with the servicing entity (MME/SGSN/VLR), of the first UE to the base station. That is, the HSS may respond to the authentication request with authentication vectors comprising the authentication information requested by the servicing entity, the first UE may be authenticated, and the location of the first UE can be updated at the HSS.

Hardware processor 702 may execute instruction 710 to, in response to a second attach request from a second UE requesting to attach to the base station, the second UE being associated with the protected IMSI, determine by the HSS that the protected IMSI is already registered with the servicing entity or that the protected IMSI's protected registration time has not yet expired. As discussed herein, protected registration times/durations can be configured to a particular temporary IMSI. In this way, if another UE attempts to attach/register with the same IMSI, and the configured protected registration time is still active, hardware processor 702 may execute instruction 712 to deny the attach request to the base station (from the second UE) in order to avoid any collision/issues associated with the first and second UE's having the same temporary IMSI. It should be noted that when a UE initially attaches to a network/registers with a network entity, such as an MME, services may be enabled or allowed to be executed/invoked by the UE, where the UE is identified by its temporary IMSI (before being assigned a permanent IMSI).

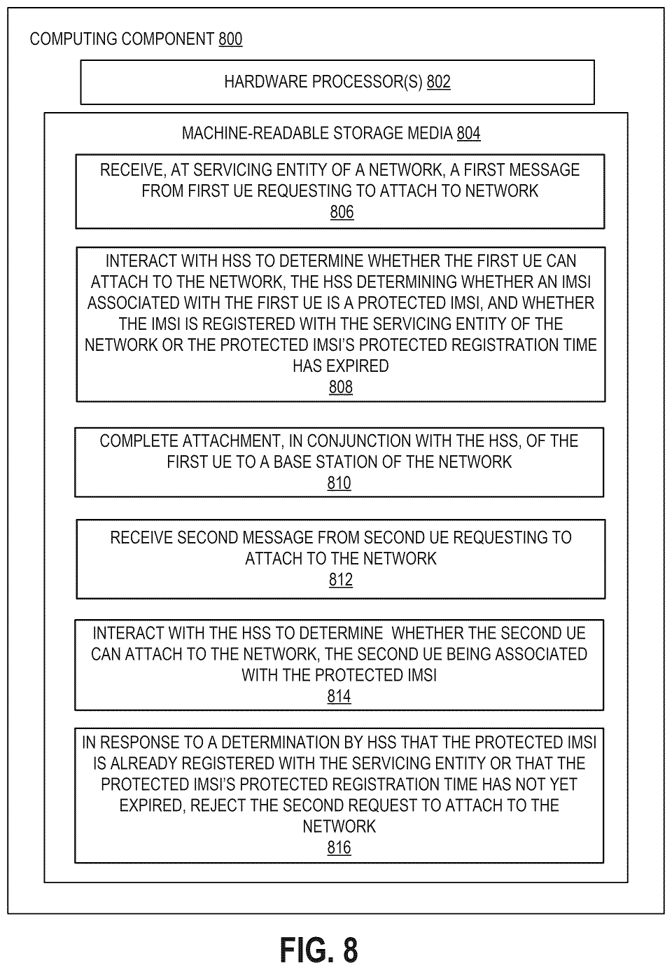

FIG. 8 illustrates a computing component that may be used to execute instructions to protected registration in accordance with examples of the disclosed technology. Referring now to FIG. 8, as already described above with respect to FIG. 7, computing component 800 may comprise hardware processor 802 and machine-readable storage media 804. Machine-readable storage media 804 may be encoded with executable instructions, for example, instructions 806-816. In some examples, computing component 800 may be used to embody MME/SGSN/VLR functionality in accordance with examples of the disclosed technology.

Hardware processor 802 may execute instruction 806 to receive, at a servicing entity of a network, a first message from a first UE requesting to attach to the network. As described herein, a UE will typically send an attach request or location update request to an MME/SGSN/VLR, examples of servicing entities of the network. A subscriber, by virtue of location, movement, roaming, powering on a UE, etc., may wish to attach a UE to a network, and the attach procedure is the procedure during which a UE can register to the network (e.g., a base station of the network) and create a bearer/tunnel between the UE and the PGW so that the UE can begin sending/receiving data over the network.

Hardware processor 802 may execute instruction 808 to interact with the HSS to determine whether the first UE can attach to the network, the HSS determining whether an IMSI associated with the first UE is a protected IMSI, and whether the IMSI is registered with the servicing entity of the network or the protected IMSI's protected registration time has expired. The servicing entity may request authentication information from the HSS in order to register the first UE. In response to this request, the HSS can make the aforementioned determinations. If permitted (e.g., the IMSI is not protected, or the IMSI is protected, but the IMSI is not registered to/with the same MME/SGSN/VLR that requested the authentication information, or the IMSI is protected, but the IMSI is outside its configured protected registration time period), the HSS can return the requested authentication information in the form of authentication vectors (in some examples). Authentication may proceed/complete, and location updating may be performed. Thereafter, hardware processor 802 may execute instruction 810 to complete attachment, in conjunction with the HSS, of the first UE to a base station of the network. At this point, the first UE may begin operating on the network, accessing allowed services, etc., where the first UE may be identified by the IMSI, which may still be the temporary IMSI.

In the event another UE is assigned the same temporary IMSI, and that other UE is attempting to attach to the network, hardware processor 802 may execute instruction 812 to receive a second message from a second UE requesting to attach to the network. The second UE may send its own attach request or location update request (that encompasses an attach request) to the servicing entity (MME/SGSN/VLR).

Hardware processor 802 may execute instruction 814 to interact with the HSS to determine whether the second UE can attach to the network, the second UE being associated with the protected IMSI. As described above, the servicing entity may request authentication information from the HSS in order to register the second UE. At this point, the HSS can again determine whether the IMSI associated with the first UE is a protected IMSI (in this example, it is), and whether the IMSI is registered with the servicing entity of the network or the protected IMSI's protected registration time has expired. If the IMSI is indeed, protected, and either the IMSI is already registered with the same servicing entity (that originated the authentication request and to which the second UE is to be registered), or the IMSI is still within its protected registration time period, the HSS can send an error coded in response to the authentication information request. The servicing entity may then respond to the second UE indicating rejection of the attach request, at which point, the second UE may attempt to select a different IMSI and try attaching to the network again.

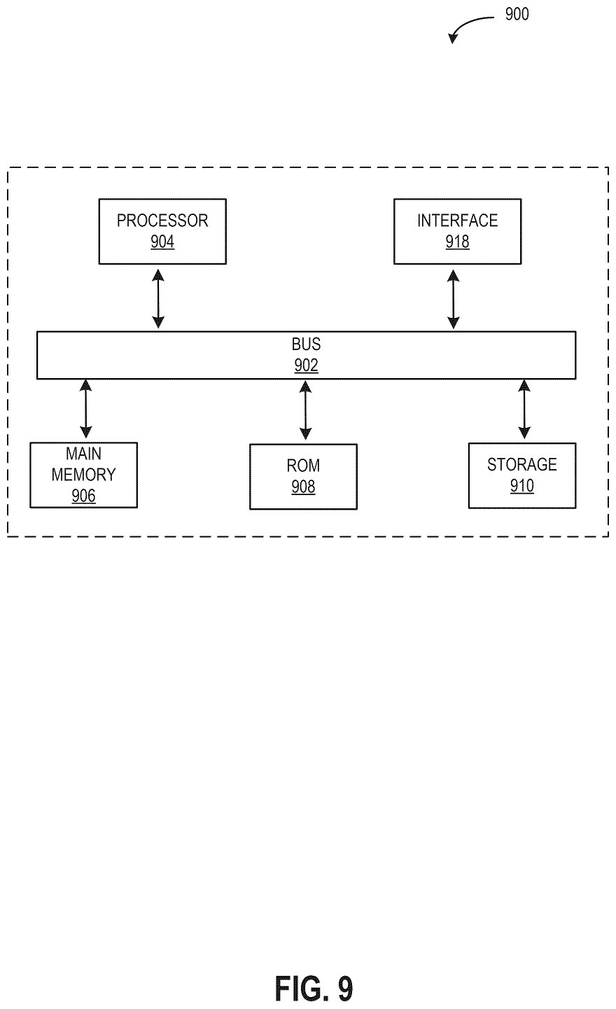

FIG. 9 depicts a block diagram of an example computer system 900 in which various examples of the disclosed technology described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one example of the disclosed technology, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same. Non-transitory media is distinct from but may be used in conjunction with transmission media.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicate with a WAN). Wireless links may also be implemented. In any such implementation, network interface 918 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method, comprising:
in response to a first request message from a first user equipment (UE) requesting to attach to a base station of a network, determine, by a home subscriber server (HSS), that an International Mobile Subscriber Identity (IMSI) associated with the first UE is a protected IMSI, and further determine that the IMSI is not registered with a servicing entity of the network or the protected IMSI's protected registration time has expired;
complete attachment, by the HSS in conjunction with the servicing entity, of the first UE to the base station of the network;
in response to a second attach request from a second UE requesting to attach to the base station, the second UE being associated with the protected IMSI, determine by the HSS, that the protected IMSI is already registered with the servicing entity or that the protected IMSI's protected registration time has not yet expired; and
deny the second attach request to the base station.

2. The computer-implemented method of claim 1, wherein the IMSI comprises a temporary IMSI.

3. The computer-implemented method of claim 1, wherein the servicing entity comprises a mobility management entity (MME).

4. The computer-implemented method of claim 1, further comprising receiving, from the servicing entity, an authentication information request specifying the IMSI.

5. The computer-implemented method of claim 4, further comprising transmitting to the servicing entity, an authentication information answer including one or more authentication information vectors including information requested in the authentication information request.

6. The computer-implemented method of claim 5, further comprising authenticating the first UE.

7. The computer-implemented method of claim 6, further comprising receiving, from the servicing entity, after authentication of the first UE, an update location request to update a location of the first UE at the HSS.

8. The computer-implemented method of claim 7, further comprising responding to the servicing entity with an update location answer including a profile associated with the first UE.

9. The computer-implemented method of claim 1, further comprising receiving, from the servicing entity, a second authentication information request specifying the IMSI.

10. The computer-implemented method of claim 9, wherein the denying of the second attach request to the base station comprises transmitting a second authentication information answer from the HSS to the servicing entity, the second authentication information answer comprising a denial error code.

11. A home subscriber server (HSS), comprising:
a processor; and
a memory unit storing instructions that when executed, cause the processor to:
exchange messages with a mobility management entity (MME) completing attachment of a first user equipment (UE) associated with an International Mobile Subscriber Identity (IMSI) to a network served by the HSS and the MME;
in response to an attach request from a second UE, the second UE also being associated with the IMSI, determine by the HSS, that the IMSI is a protected IMSI, and either that the IMSI is already registered with the MME or that a protected registration time associated with the IMSI has not yet expired; and
deny the second attach request on.

12. The HSS of claim 11, wherein the instructions that when executed cause the processor to exchange messages with the MME completing attachment of the first UE to the network comprise messages transmitted and received over an S6a interface.

13. The HSS of claim 11, wherein the instructions that when executed cause the processor to exchange messages with the MME completing attachment of the first UE to the network comprise instructions that further cause the processor to receive an authentication information request specifying the IMSI from the MME.

14. The HSS of claim 13, wherein the instructions that when executed cause the processor to exchange messages with the MME completing attachment of the first UE to the network comprise instructions that further cause the processor to transmit to the MME, an authentication information answer including one or more authentication information vectors including information requested in the authentication information request.

15. The HSS of claim 14, wherein the instructions that when executed cause the processor to exchange messages with the MME completing attachment of the first UE to the network comprise instructions that further cause the processor to receive, from the MME, an update location request to update a location of the first UE at the HSS.

16. The HSS of claim 15, wherein the instructions that when executed cause the processor to exchange messages with the MME completing attachment of the first UE to the network comprise instructions that further cause the processor to respond to the MME with an update location answer including a profile associated with the first UE.

17. A computer-implemented method, comprising:
receive, at a servicing entity of a network, a first message from a first user equipment (UE) requesting to attach to the network;
interact with a home subscriber server (HSS) to determine whether the first UE can attach to the network, the HSS determining whether an International Mobile Subscriber Identity (IMSI) associated with the first UE is a protected IMSI, and whether the IMSI is registered with the servicing entity of the network or the protected IMSI's protected registration time has expired;
complete attachment, in conjunction with the HSS, of the first UE to a base station of the network;
receive a second message from a second UE requesting to attach to the network;
interact with the HSS to determine whether the second UE can attach to the network, the second UE being associated with the protected IMSI;
in response to a determination by the HSS that the protected IMSI is already registered with the servicing entity or that the protected IMSI's protected registration time has not yet expired, reject the second request to attach to the network.

18. The computer-implemented method of claim 17, wherein the interacting with the HSS to determine whether the first UE can attach to the network comprises authenticating the first UE and updating a location of the first UE at the HSS.

19. The computer-implemented method of claim 18, further comprising receiving confirmation of completed attachment from the first UE.

20. The computer-implemented method of claim 17, wherein the interacting with the HSS to determine whether the second UE can attach to the network comprises exchanging authentication information request and answer messages, the MME receiving the authentication information answer message from the HSS indicating an error.
